(19) United States
(12) Patent Application Publication
(10) Pub. No.: US 2016/0000075 A1
(43) Pub. Date: Jan. 7, 2016

(54) USE OF PYRIMIDINES IN STIMULATION OF PLANT GROWTH AND DEVELOPMENT AND ENHANCEMENT OF STRESS TOLERANCE

(71) Applicants: Asuman CANSEV, (US); Hatice GÜLEN, (US); Müge KESICI ZENGIN, (US); Sergül ERGIN, Yerleskesi, Eskisehir (TR); Mehmet CANSEV, (US); Nabi Alper KUMRAL, (US); ULUDAG ÜNIVERSITESI TEKNOLOJI TRANSFER OFISI TICARET VE SANAYI ANONIM SIRKETI, NILÜFER, Bursa (TR)

(72) Inventors: Asuman CANSEV, Bursa (TR); Hatice GÜLEN, Bursa (TR); Müge KESICIZENGIN, Bursa (TR); Sergül ERGIN, Eskisehir (TR); Mehmet CANSEV, Bursa (TR); Nabi Alper KUMRAL, Bursa (TR)

(21) Appl. No.: 14/769,652

(22) PCT Filed: Feb. 21, 2014
(86) PCT No.: PCT/TR2014/000051

§ 371 Date: Aug. 21, 2015

(30) Foreign Application Priority Data
Feb. 21, 2013 (TR) 2013/02102
Feb. 21, 2013 (TR) 2013/02103
Feb. 20, 2014 (TR) 2014/01995

(51) Int. Cl. A01N 43/54

(52) U.S. Cl. CPC A01N 43/54

(57) ABSTRACT

Disclosed is the use of pyrimidines, especially uridine and cytidine chemicals of pyrimidines in stimulation of plant growth and development, as well as use of pyrimidines especially uridine in enhancement of stress tolerance, reduction of stress, repair of stress-related injury and inhibition of stress, and the methods thereof.

### THE RELATED ART

The invention relates to use of pyrimidine molecules in the sector of agriculture.

The invention particularly relates to the use of said pyrimidine molecules in promoting growth and development of plants and increasing their tolerances against biotic and abiotic stress factors.

### THE PRIOR ART

Various internal and external factors, especially their genetic structures, are effective on growth and development of plants. External factors can be listed as temperature, light, soil etc. environmental or ecological factors. Internal factors comprise hormone, carbohydrate, lipid, enzyme, and secondary metabolites etc. all of the biochemical molecules synthesized within the plant. Almost all of these substances are natural or organic substances that can be produced, within the plant, can be transferred from the site of production to other parts of the plant where they are needed, and can be effective even in very low amounts. Among these substances, which are required for various physiological phases and metabolisms of plants, especially the impact of hormones is of significance and specific effects of species or genera are determined and their new effects are being discovered day by day. These substances are formed of growth promoters (auxins, cytokinines, and gibberellins), growth preventers (abscisic acid), ethylene, which is the hormone in the form of a gas that is synthesized in connection with maturation or aging. Besides these ones, studies about the use of brassinosteroids, salicylic acid, jasmonic acid, and polyamines are also present, which are also recently obtained from plants and their hormonal effects being proven. Therefore, these substances are frequently applied externally with the purpose of control and management of growth and development of plants. Synthetic commercial productions of these natural substances that are synthesized from plants are used in external applications. Since obtaining of natural hormones synthesized in the plant via purification is a very difficult, inefficient, and costly process, substances with similar characteristics can be produced synthetically. Except ethylene, the chemical structures of these hormones that are produced synthetically are not same with the natural plant hormones. However, they may have the same or similar effect when they are administered.

Use of these substances in agriculture is subject to pesticide applications and requires registration and authorization by the Ministry of Food, Agriculture and Livestock. Therefore, all kinds of research and trials of these substances that are synthetically produced by the companies are made in an extremely sensitive manner so that they can have place in practical use according to the results of these research and trials. The impacts of the hormones on the plants can vary according to the concentration of application, time of application, the physiological stage in which the plant is found, the age of the plant, the type and the genus of the plant, the member of the plant, and the ecological condition of the plant at the time of administration. Therefore, it is of great importance to follow the recommended authorized instructions in use of these substances in control and management of growth and development of plants. While these substances that are synthetically produced and used can cause harmful effects on the plants in case of overdose or faulty application situations, they may also pose threat on food safety by means of leaving residue in the food.

Although stress is physically defined as force applied to unit area, in biological terms, it is defined as the impact of an external factor on an organism (Levitt, 1980). Stress factors affecting agricultural production are classified as biotic and abiotic factors. While patogens, microorganisms, weeds, insects etc. are evaluated as biotic stress factors; temperature, drought, radiation, salinity, plant nutrients, light, flood, mechanical impacts (wind, snow and ice mantle), air pollution, toxins etc. environmental factors are defined as abiotic stress.

Abiotic stress conditions, besides negatively affecting growth and development of plants, also cause increase in lose of efficiency more than 50% in fundamental products (Wang et. al., 2004). Various external and internal factors, especially the genetic structures are effective in tolerance of plants against abiotic stresses and defence mechanisms in physiological and molecular levels play role against these problems.

Stress causes some physiological, biochemical, and molecular changes in plant metabolism (Levitt 1980). In plants, most of the changes that occur during adapting to high temperatures are reversible. However, if the magnitude of the stress is high, changes that are irreversible may occur and may cause death of the plant.

Environmental factors of a region significantly affects the growth of plant types or kinds and the most important one among these factors is the temperature. Temperature stress recently increasing together with global warming causes efficiency and dry substance ratio losses especially in moderate climate regions (Levitt 1980, Giaveno and Ferrero 2003, Wahid et al. 2007). Human activities cause increase of carbondioxide, methane, chlorofluorocarbon, and nitrogen oxide etc. greenhouse gas concentrations found in the atmosphere, which contributes to global warming (Wahid et. al. 2007). According to IPCC (Intergovernmental Panel on Climatic Change) 2012 report; global temperature is expected to increase at around 1-3° C. towards the mid-21^{st} century, while it is expected to increase 2-5° C. until the end of the 21^{st} century.

Temperature stress is generally defined as the increase of temperature above the threshold for a certain time that causes irreversible damages in plant growth and development. Temporary increase in environmental temperature around 10-15° C. is defined as temperature shock or temperature stress. However, temperature stress occurs according to density (degree temperature), time period, and rate of increase of temperature (Eris 2003).

Cellular damages are caused by the presence of reactive oxygen derivatives (ROS) occurring due to oxidative stress triggered by temperature (Kumar et. al. 2007). Superoxide (O2⁻), hydrogen peroxide (H₂O₂), and hydroxyl radicals (OH), which are known as ROS, are formed as a result of interaction of metabolism with oxygen. ROS inhibit the enzymes and have harmful effect on important cellular components and their production is significantly increased under high stress conditions (McKersie and Lehsem 1994). Plants and other organisms have developed various mechanisms in order to reduce and repair the damages caused by ROS. Molecular defence mechanism of plants is a part of environmental stress factors and enables gaining stress tolerance (Peet and Willits 1998).

For instance; under stress conditions, various plant types accumulate various osmolites such as sugars and sugar alcohols (poliols), proline, tertiary, and quaternary ammonium compounds, and tertiary sulfonium compounds (Sairam and Tyagi 2004). Hormones such as abscisic acid (ABA) and ethylene (C₂H₄) regulate various physiological events by means of triggering signal molecules during stress (Larkindale and Huang 2005). Moreover, high temperature stress causes accumulation of phenolic compounds, which are the most significant secondary metabolites taking part in tolerance against abiotic stress in plants (Wahid and Ghazanfar 2006, Wahid 2007). Another defence system developed by plants against stress is the antioxidant defence system (Foyer et. al. 1994). The antioxidant defence system of plants is formed of antioxidant molecule and enzymes (Alscher et. al. 1997). By means of complex cooperation of enzymatic and non-enzymatic antioxidants, control of ROS concentrations and repairment of oxidative damages are possible (Smirnoff 2005).

Another one of the defence systems taking part in abiotic stress tolerance is the synthesis of stress proteins. Protection of protein structures and functions under stress conditions is very important for survival of the cell (Wang et. al. 2004). Temperature stress also has negative impacts on the protein structure and activity (Wery et. al. 1993). It is found that normal cellular proteins are reduced, whereas heat shock proteins (HSP) are increased when plants are exposed to high temperature. HSP's are responsible for protein folding, mounting, translocation, and destruction in various normal cellular process and prevent re-folding and denaturation of proteins under stress conditions (Hartl 1996, Boston et. al. 1996, Wang et. al. 2004).

Exposure to extreme temperature changes, salinity, drought etc. environmental stresses leads to lack of water in plant tissue. Under these conditions, plants try to survive by synthesizing and accumulating various osmolites (or osmoprotectants) in order to be able to prevent the loss of the water found in their cells (Williamson et. al. 2002). Metabolic regulation made by means of accumulation of various organic substances is a fundamental strategy for survival of plants and their protection against extreme environmental conditions. Besides their ability of regulating the osmotic pressure of cellular cytoplasm under stress conditions such as freezing, drought etc., these metabolites also stabilize the cellular membranes and proteins (Bohnert and Jensen 1996; McNeil et. al. 1999). Osmolites are generally found in stable state within the cell, can not be metabolized easily, and do not have any toxic effect against cellular functions even when they are accumulated in high concentrations (Charron et. al. 2002, Peel et. al. 2009). Therefore, they are important for adaptation of plant cells against various negative environmental conditions (Yancey 1994).

Among the quaternary ammonium compounds of osmolites responding to dehydration stresses in plants, the most commonly known is glycine betain (GlyBet) (Venkatesan and Chellappan 1998, Mansour 2000, Mohanty et. al. 2002, Yang et. al. 2003). With the accumulation of these compounds, low water potential occurs in the cell and in this case water enters into cell. There are various studies about the healing effects of GlyBet on the damages formed at cellular membranes and proteins due to stress (Brady et. al., 1984; Paleg et. al., 1984; Arakawa and Timasheff, 1985; Incharoensakdi et. al., 1986; Ashihara et. al., 1997; Mansour 1998).

As disclosed above, following determination of the internal roles of GlyBet under stress conditions for various plant types, studies have been made showing that external administration of this molecule is also effective. It is shown that external GlyBet administrations increase low temperature stress tolerance in plant species such as Arabidopsis thaliana, Solanum tuberosum, Fragaria×ananassa, Medicago sativa, Triticum aestivum, Zea mays etc. (Zhao et. al. 1992, Somersalo et al. 1996, Allard et. al. 1998, Sakamoto and Murata 2000, WeiBing and Rajashekar 2001, Xing and Rajashekar 2001, Park et. al. 2003, Park et. al. 2006). For example, it is shown that external administration of GlyBet increases tolerance against frost in cabbage (Sakai and Yoshida 1968) and clover (Zhao et. al. 1992).

In external administration of GlyBet, it can easily be taken from the leaves (Park et. al. 2006). For instance, it is found that big′ portion of GlyBet administered on the leaves of tomato plant is absorbed by the leaves and transferred to cytosol (Park et. al. 2006). It is reported that radioactive-labelled GlyBet is transferred from the leaves of turnip plant (Brassica rapa L.) to the roots within 2 hours. In the study, it is also reported that, after 24 hours, all members of the plant carry glycine betain (Makela et. al. 1996). In tomato plant, following application of GlyBet through the leaf, it is found to be accumulated in all meristamatic cells comprising sprout and shoot of the flower. In this study, it is found that GlyBey is transported to the actively growing and developing regions via phloem (Park et al. 2003).

As one of the substances used in external applications for tolerance against stress, spermidine, among the polyamine class, is shown to increase high temperature tolerance in tomato at 4 mM concentration (Murkowski 2001).

Besides these, the abscisic acid (ABA) and the jasmonic acid among the hormones for increasing stress tolerance are known to have protective effects in cellular base. However, these substances are not commonly used in agricultural production. Moreover, since the protective effect of the plant nutrient copper against stress is known, external applications of copper-containing preparations have practical significance in commercial applications. These preparations are commonly used in agricultural production since they are inexpensive and easy to apply. However, since these preparations are applied on the plants via spraying, washed by rain water and thus accumulate in soil and water sources, they have the potential to cause environmental pollution. Therefore, there is a need for alternative strategies to improve stress tolerance in plants. In this context, pyrimidines, having proven effects against cellular damages in animal organisms, are believed to have potential protecting, stress tolerance-increasing, and stress supressing etc. effects also in plants.

Pyrimidines are heterocyclic organic aromatic compounds having chemically similar characteristics with benzene and pyridine. The pyrimidine nucleosides uridine, cytidine, and thymidine and their phosphate-bound nucleotide forms are normally found in the body and take part in various physiological functions. Among these, the functions which have been studied especially well are the ones that are related to the roles they take in glycogen metabolism and nucleic acid synthesis.

Although there is no example about plantal application of pyrimidine compounds, a patent about increasing of growth hormones, especially auxin synthesis by means of uridine extracts has been encountered (WO1997000614A1). In this study, it is found that, uridine, which is one of the substances formed as a result of degradation of cellular structures in culture medium, increases cellular regeneration (compared to only using auxin in culture medium) by means of increasing the effect and/or synthesis of auxin.

Polyamine extracts obtained from plants have been reported to prevent stress in plants (EP2486920A1). In this invention, a patent document is mentioned (Japanese Unexamined Patent Application Publication No. 2005-330213) wherein the stress-preventive effect of uridine is examined in relation to nucleic acids.

A patent is published about providing strength against stress together with growth and increase in efficiency by means of synthesis of enzyme in relation to cellulose and transfer of the DNA index controlling this to a plant cell through bacteria (CA2264957A1). Here, in synthesis of enzymes related to cellulose, the precursor is emphasized to be uridine diphosphate glucose (UDP-glucose). As a result of culture studies, presence of uridine diphosphate glucose is stated to be indirectly important in terms of growth, efficiency, and stress tolerance in plants.

However, in above given patents, no findings have been encountered in relation with the effects of pyrimidine compounds of the present invention under stress conditions.

### PATENT REFERENCES

| | File | | | |
|---|---|---|---|---|
| | Admission | Publication | Owner of | |
| Patent cited | Date | Date | Application | Title |
| WO1997000614A1 | 24 Jun. 1996 | 9 Jan. 1997 | Instituut Voor | Influencing the |
| | | | Agrobiologisch | activity of plant |
| | | | | growth regulators |
| EP2486920A1 | 28 Sep. 2009 | 15 Aug. 2012 | Toyo Boseki | Stress-alleviating |
| | | | Kabushiki | agent comprising |
| | | | Kaisha | plant-derived |
| | | | | polyamine-containing |
| | | | | extract as active |
| | | | | ingredient |
| CA2264957A1 | 9 Sep. 1997 | 19 Mar. 1998 | B.C. Research | A process of |
| | | | Inc. | increasing plant |
| | | | | growth and yield and |
| | | | | modifying cellulose |
| | | | | production in plants |

### Chemical Structures of Pyrimidine Compounds

Pyrimidine compounds are heterocyclic organic aromatic compounds chemically similar to benzene and pyridine, and carry one each nitrogen atom at the positions of 1 and 3 of the 6-membered chemical ring. Pyrimidines are found in base, nucleoside, and nucleotide forms.

Pyrimidine bases are principally included in the structure of DNA and RNA. While cytosine is found in both DNA and RNA structure, thymine is only found in DNA and uracil is only found in RNA structure. Chemical structure of pyrimidine bases are given in FIG. 1.

FIG. 1 shows the chemical structures of pyrimidine bases. Pyrimidine nucleosides are formed by addition of a sugar molecule in the form of ribose or 2-deoxyribose to pyrimidine bases. In this reaction, the carbon no 1 of the sugar molecule is combined with the nitrogen no 1 of the pyrimidine base. The pyrimidine nucleoside formed is defined by means of adding “-idine” suffix at the end of the base name (for instance uridine). When ribose is added to bases, the nucleosides formed do not have any suffix, but when 2-deoxyribose is added, the prefix “d-” is added before the name. Chemical structures of pyrimidine nucleosides are given in FIG. 2.

FIG. 2 shows the chemical structures of pyrimidine nucleosides. Pyrimidine nucleotides are formed by addition of phosphate groups to nucleosides. The number of phosphate groups added determines the name of that nucleotide; and the prefixes mono-, di-, or tri-phosphate are added to the nucleoside name when one, two, or three phosphate groups are added, respectively. The nucleotides formed when three phosphate groups are added to pyrimidine nucleosides are shown in FIG. 3 (In FIG. 3, the chemical structures of the pyrimidine nucleotides comprising three phosphate group are given).

### THE PURPOSE OF THE INVENTION

The present invention relates to use of pyrimidine compounds in promoting growth and development of plants and increasing their stress tolerances, which meets above said requirements, eliminates some of the drawbacks, and brings about some additional advantages.

The primary purpose of the invention is to provide the uridine and cytidine chemicals with the purpose of promoting the growth and development of plants.

A purpose of the invention is to prevent harm on growth of plants by use of said uridine or cytidine chemicals in appropriate doses, prevent formation of carcinogenic affect on humans, since it is naturally found in human body, and be nontoxic.

Another purpose of the invention is to provide easy storage, since it is durable against decomposition at room temperature in powder form.

In order to achieve above said purposes, the invention comprises use of uridine or cytidine chemicals in promotion of plant growth and development.

In order to achieve the purposes of the invention, said uridine or cytidine solution is prepared between 10⁻⁹-1 molar.

In order to achieve the purposes of the invention, said solution comprises 0.000243-243000 m uridine in 1 litre of water.

In order to achieve the purposes of the invention, said solution comprises 0.000244-244000 mg uridine in 1 litre of water.

In order to achieve the purposes of the invention, said uridine or cytidine solution is preferably prepared between 10⁻⁶ to 10⁻⁴ molar.

In order to achieve the purposes of the invention, said solution comprises 0.243-24.3 mg cytidine in 1 litre of water.

In order to achieve the purposes of the invention, said solution comprises 0.244-24.4 mg uridine 1 litre of water.

In order to achieve the purposes of the invention, sowing is made in a way that 1 seed would be present in each viol cell.

In order to achieve the purposes of the invention, said germination is made at 25° C.

In order to achieve the purposes of the invention, plants are kept under light at 24° C. and 22° C. for 16 hours per day and kept under dark conditions at 20° C. for 8 hours.

The primary purpose of the invention is to use uridine for increasing the stress tolerances of plants.

A purpose of the invention is to prevent harm on growth of plants by use of said uridine chemical in appropriate doses, prevent formation of carcinogenic affect on humans, since it is naturally found in human body, and be nontoxic.

Another purpose of the invention is to provide easy storage of said chemical, since it is durable against decomposition at room temperature in powder form.

In order to achieve above said purposes, the invention comprises use of uridine chemical in promotion of plant growth and development.

In order to achieve the purposes of the invention, said uridine solution is prepared between 10⁻⁹-1 molar.

In order to achieve the purposes of the invention, said solution comprises 0.000244-244000 mg uridine in 1 litre of water.

In order to achieve the purposes of the invention, said uridine solution is preferably prepared between 10⁻⁵ to 10⁻⁴ molar.

In order to achieve the purposes of the invention, said solution comprises 0.244-24.4 mg uridine 1 litre of water.

In order to achieve the purposes of the invention, sowing is made in a way that 1 seed would be present in each viol cell.

In order to achieve the purposes of the invention, said germination is made at 25° C.

In order to achieve the purposes of the invention, plants are kept under light at 24° C. and 22° C. for 16 hours per day and kept under dark conditions at 20° C. for 8 hours.

For high temperature stress applications, the temperature of the growth cabinet is increased gradually to 35, 40, and 45° C. and kept for 24 hours at each temperature level.

Following application of 45° C., total amount of soluble protein is measured in the leaf samples taken from the plants.

### FIGURES FOR BETTER UNDERSTANDING OF THE INVENTION

FIG. 1 shows the chemical structures of pyrimidine bases.

FIG. 2 shows the chemical structures of pyrimidine nucleosides.

FIG. 3 shows the chemical structures of pyrimidine nucleotides comprising three phosphate groups.

FIG. 4: is the graphical view showing the effect of the 10 μM concentration solution prepared from uridine (A) or cytidine (B) molecule of the invention on the hypocotyl height of the seedlings.

FIG. 5: is the graphical view showing the effect of the 10 μM concentration solution prepared from uridine (A) or cytidine (B) molecule of the invention on the epicotyl height of the seedlings.

FIG. 6: is the graphical view showing the effect of the 10 μM concentration solution prepared from uridine (A) or cytidine (B) molecule of the invention on the plant height of the seedlings.

FIG. 7: is the graphical view showing the effect of the 10 μM concentration solution prepared from uridine (A) or cytidine (B) molecule of the invention on the 1^{st} actual leaf area of the seedlings.

FIG. 8: is the graphical view showing the effect of the 10 μM concentration solution prepared from uridine (A) or cytidine (B) molecule of the invention on the 2^{nd} actual leaf area of the seedlings.

FIG. 9: is the view of the parts of a plant.

FIG. 10 shows the total soluble protein amounts in control cucumber plants (high temperature and no uridine application), plants with application of only uridine at various concentrations, and plants with application of uridine and high temperature stress (45° C.) together.

FIG. 11 is view of control plants (high temperature and no uridine application), plants with application of only uridine (A) and plants with and without application of uridine (B) under high temperature stress (45° C.).

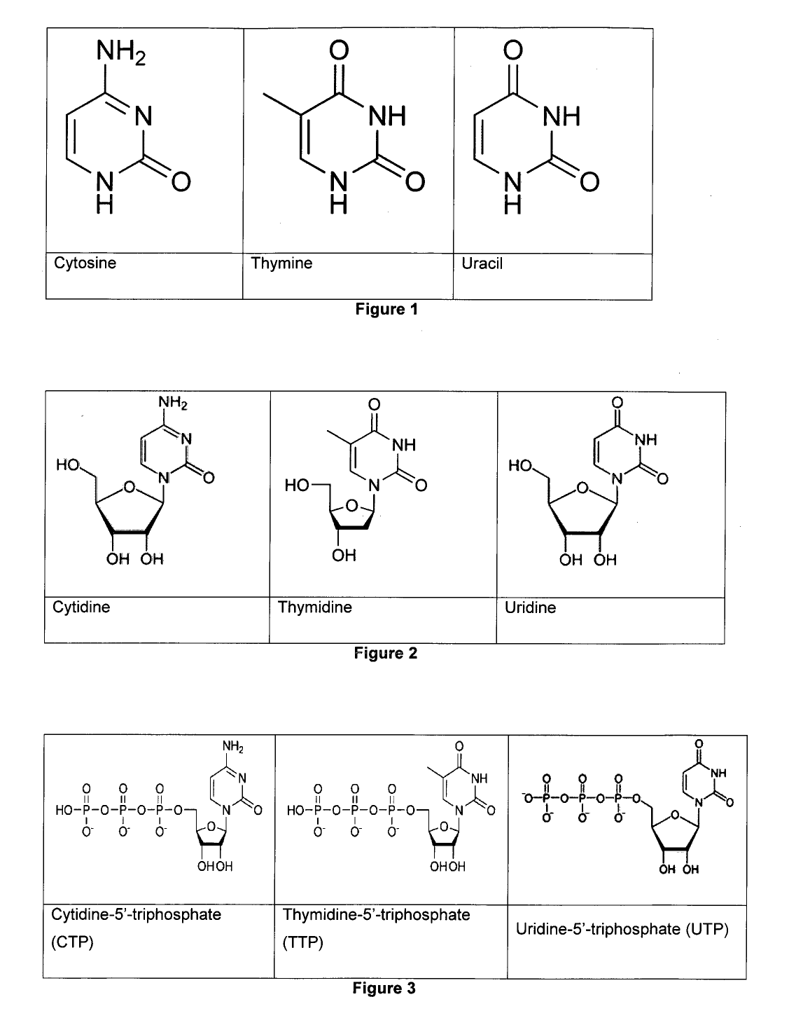

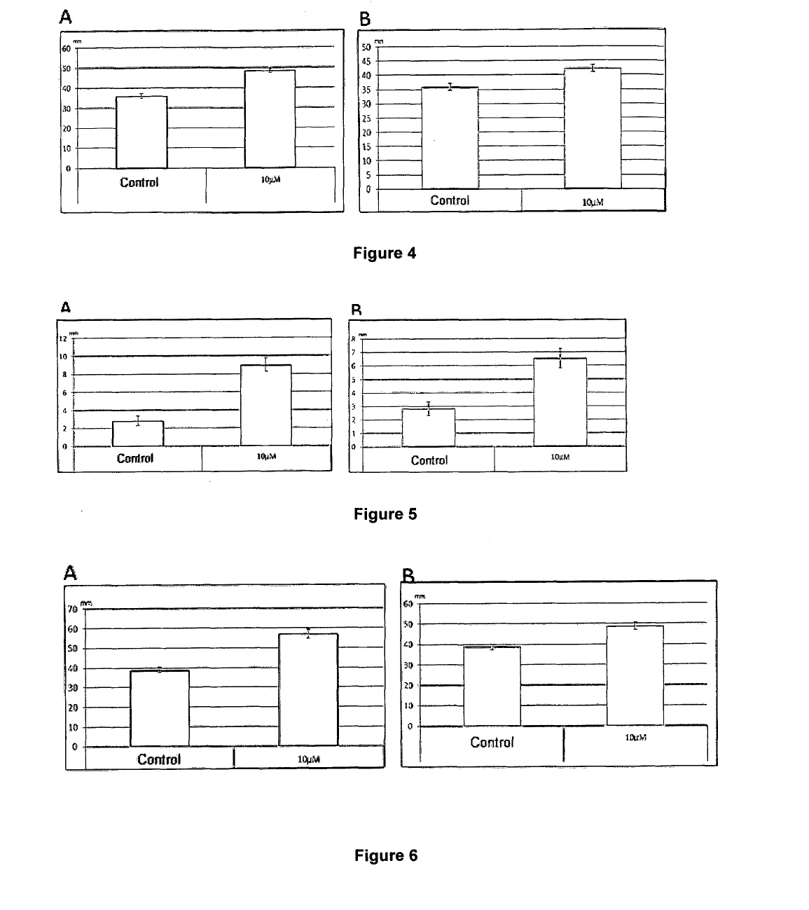

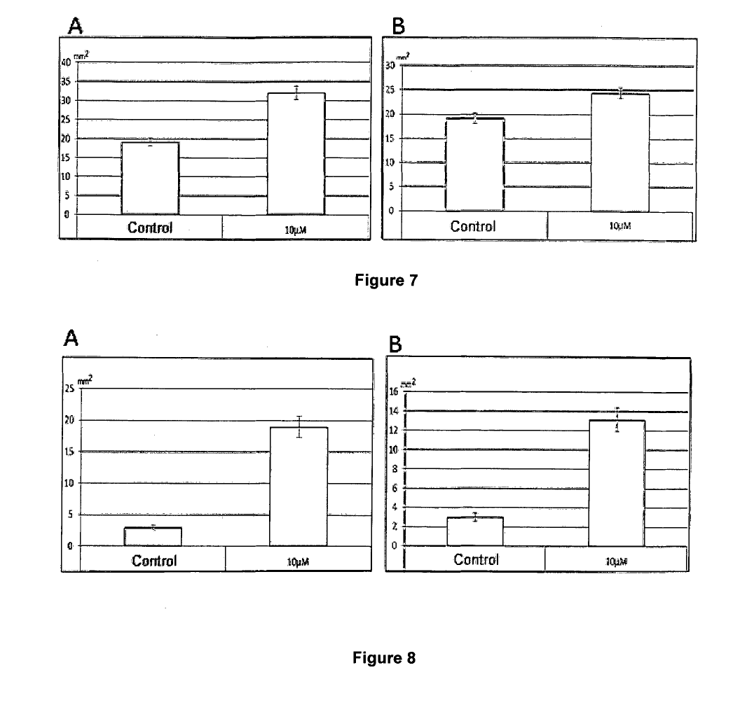

### DETAILED DESCRIPTION OF THE INVENTION

In this detailed description, the preferred embodiments of the use of pyrimidine compounds of the invention in promoting growth and development of plants and increasing their stress tolerances are described for better understanding of the invention without forming any limiting effect.

The invention relates to use of uridine and cytidine chemicals and other pyrimidine compounds in agriculture sector; especially for promoting growth and development of plants and increasing their stress tolerances.

Pyrimidine is the general name of nitrous aromatic bases generally found in nucleic acids and also in some coenzymes and vitamins.

The most basic pyrimidine structure is C₄H₄N₂ and the pyrimidines are the derivatives of this main structure.

Three pyrimidine bases (cytozine, thymine, and uracil) are found in biologic systems. Uracil is only found in ribonucleic acid (RNA), thymine in deoxyribonucleic acid (DNA), and cytozine in both DNA and RNA. The shapes and sizes of pyrimidines- and also the ability of forming hydrogen bonds with the purines provide the three-dimensional structures and the biological functions of nucleic acids.

Besides their uracil, cytozine, and thymine base forms, pyrimidine compounds can have the structure of nucleoside such as uridine, cytidine, and thymidine, respectively, which are formed by addition of a ribose ring to these bases through beta-N-glycosidic bond; deoxy nucleoside structure such as deoxyuridine, deoxycytidine, and deoxythymidine, respectively, which are formed by addition of a deoxyribose ring to these bases through beta-N-glycosidic bond; nucleotide structure such as uridine-5′-monophosphate, uridine-5′-diphosphate, uridine-5′-triphosphate, cytidine-5′-monophosphate, cytidine-5′-diphosphate, cytidine-5′-triphosphate, thymidine-5′-monophosphate, thymidine-5′-diphosphate, thymidine-5′-triphosphate, which are the one-, two-, or three-phosphate added forms of these nucleosides; deoxy forms of these nucleotides; and structures such as cytidine-5′-diphosphate choline, cytidine-5′-diphosphate ethanolamine, uridine-adenosine tetraphosphate, which are the structures wherein choline, ethanolamine, adenosine etc. are added to these nucleotides.

Cytidine is a pyrimidine nucleoside. It is found in plant (Ross, 1965) and animal (Traut, 1994) tissues. In plants, it takes part in synthesis of cytidine-5′-diphosphate (CDP) and cytidine-5′-triphosphate (CTP) (Ross and Cole, 1968). It is included in the structure of RNA in the same ratio with uridine (Ross and Cole, 1968). In addition, following deamination reaction in plants, some part of the cytidine is transformed into uridine (Ross and Cole, 1968). While cytidine is the major pyrimidine in blood circulation of rats (Traut, 1994), in human blood circulation the major pyrimidine is uridine (Wurtman et. al., 2000). Moreover, as in the plants, also in humans, cytidine provided externally to the body is quickly transformed into uridine as a result of deamination (Wurtman et. al., 2000). Cytidine is transformed into CTP and cytidine-5′-diphosphate choline (CDP-choline) through Kennedy pathway and thus takes part in membrane phospholipid synthesis (Kennedy and Weiss, 1956).

CDP-choline, which is derived from cytidine, is studied extensively in terms of its neuroprotective effects in animal experiments and some clinical studies. CDP-choline reduces damage in hypoxic and ischemic brain injuries and improves the learning and memory functions which are impaired with aging (Secades, 2011). With these features, it is suggested to be useful as neuroprotective in cases of stroke, traumatic brain injury, and Alzheimer disease (Secades, 2011).

Uridine is a pyrimidine nucleoside and a constituent of plant (Ross, 1965) and animal (Pelling, 1959) tissues. Uridine is also the constituent of nucleotides comprising mono-(uridine-5′-monophosphate [UMP]), di-(uridine-5′-diphosphate [UDP]) and tri-phosphate (uridine-5′-triphosphate [UTP]), nucleotide sugars (UDP-glucose and UDP-galactose) (Ross and Cole, 1968) and phospholipid intermediate metabolites (Kennedy and Weiss, 1956) cytidine-5′-triphosphate (CTP) (Genchev and Mandel, 1974) and cytidine-5′-diphosphate choline (CDP-choline) (Cansev et. al., 2005) compounds. Uridine plays role in various physiological functions such as glycogen and phospholipid biosynthesis and protein and lipid glycosylation (Lecca and Ceruti, 2008). RNA synthesis has a vital role in plant growth and development (Oota, 1964) and experimental disintegration of RNA affects growth and development (Brachet, 1954). Membrane phospholipids are also the most important components of cell membranes and cell growth and reproduction are associated with the increase of membrane phospholipid synthesis in both plants (Xue et. al., 2009) and animal cells (Bashir et. al., 1992) and tissues (Wurtman et. al., 2009). It is also shown that UMP, which is a source of uridine, is transformed into uridine after entering into body and reaches the brain (Cansev et. al., 2005) and improves phospholipid production (Wurtman et. al., 2006) or neuron branching and thus neural communication in infant (Cansev et. al., 2009) or adult (Sakamoto et. al., 2007) experimental animals. The uridine added to the neurons in the culture also increases the growth and branching of these cells (Pooler et. al., 2005). With above said characteristics, uridine treatment is found to increase learning and memory functions in experimental animals (Teather and Wurtman, 2006; Holguin et. al., 2008a) and also in environmentally impoverished animals (Holguin et. al., 2008b). In addition, uridine reduces brain damage of laboratory animals in experimental models. For instance, in experimental Parkinson model, uridine administered in the form of UMP ameliorated brain lesion and reduced rotational behaviour, which is the typical indication of damage (Cansev et. al., 2008). Moreover, uridine treatment significantly reduced the level of damage in infant rats, which are exposed to hypoxic ischemic brain damage (Cansev et. al., 2013). Prevention of programmed cell death (apoptosis) mechanism of brain cells by uridine mediated to this effect (Cansev et. al., 2013).

In the prior art, when uridine is used on humans; it is known that it causes diarrhea when it is taken in high oral dosage such as 10 g per day (van Groeningen et. al., 1991) and the dose of 10 g/m² administered intravenously is known to cause shaking (Leyva et. al., 1984).

### Experiment 1

### Promotion of Plant Growth and Development Through Administration of Uridine or Cytidine

In the present invention, said uridine or cytidine chemical is used on plants.

### Amount of Uridine Chemical Usage in the Invention:

| RAW | PREFERRED AMOUNT | USABLE AMOUNT |
|---|---|---|
| MATERIAL | (gr) | (gr) |
| Uridine | 10⁻⁵-10⁻⁴ molar (1-100 | 10⁻⁹-1 molar (1 nanomolar- |
| | micromolar): 2.44-24.4 mg | 1 molar): 0.000244-244000 |
| | | mg |
| Water | 1 litre | 1 litre |

Said uridine is administered on cucumber (Cucumis sativus) plants in the preferred embodiment of the invention.

### Amount of Cytidine Chemical Usage in the Invention:

| RAW | PREFERRED AMOUNT | USABLE AMOUNT |
|---|---|---|
| MATERIAL | (gr) | (gr) |
| Cytidine | 10⁻⁶-10⁻⁴ molar (1-100 | 10⁻⁹-1 molar (1 nanomolar- |
| | micromolar): 0.243-24.3 mg | 1 molar): 0.000243-243000 |
| | | mg |
| Water | 1 litre | 1 litre |

Said cytidine is administered on cucumber (Cucumis sativus) plants in the preferred embodiment of the invention.
Their sowing is preferably made into vials of 72 such that 1 seed would be present per vial.
Said seeds are germinated at 25° C. in plant growth cabin.
Following the stage of germination, 10 ml of uridine or cytidine solution prepared at 10 or 100 μM concentration is administered to the plants twice a week.
Water is used as dissolver in order to dissolve uridine or cytidine (it is preferably dissolved in pure water and at room temperature).

### Preparation of Uridine Solution:

### For the Usable Amount of the Invention:

In order to prepare 10⁻⁹ M (1 nano molar) solution; 0.000244 mg uridine is dissolved in 1 L of water.
In order to prepare 1 M (1 molar) solution; 244000 mg uridine is dissolved in 1 L of water.

### For the Preffered Amount of the Invention:

In order to prepare 10 μM solution; 2.44 mg uridine is dissolved in 1 L of water.
In order to prepare 100 μM solution; 24.4 mg uridine is dissolved in 1 L of water.
Uridine solution should be prepared fresh for each administration.

### Preparation of Cytidine Solution:

### For the Usable Amount of the Invention:

In order to prepare 10⁻⁹ M (1 nano molar) solution; 0.000243 mg cytidine is dissolved in 1 L of water.
In order to prepare 1 M (1 molar) solution; 243000 mg cytidine is dissolved in 1 L of water.

### For the Preffered Amount of the Invention:

In order to prepare 10 μM solution; 2.43 mg cytidine is dissolved in 1 L of water.
In order to prepare 100 μM solution; 24.3 mg cytidine is dissolved in 1 L of water.
Cytidine solution should be prepared fresh for each administration.

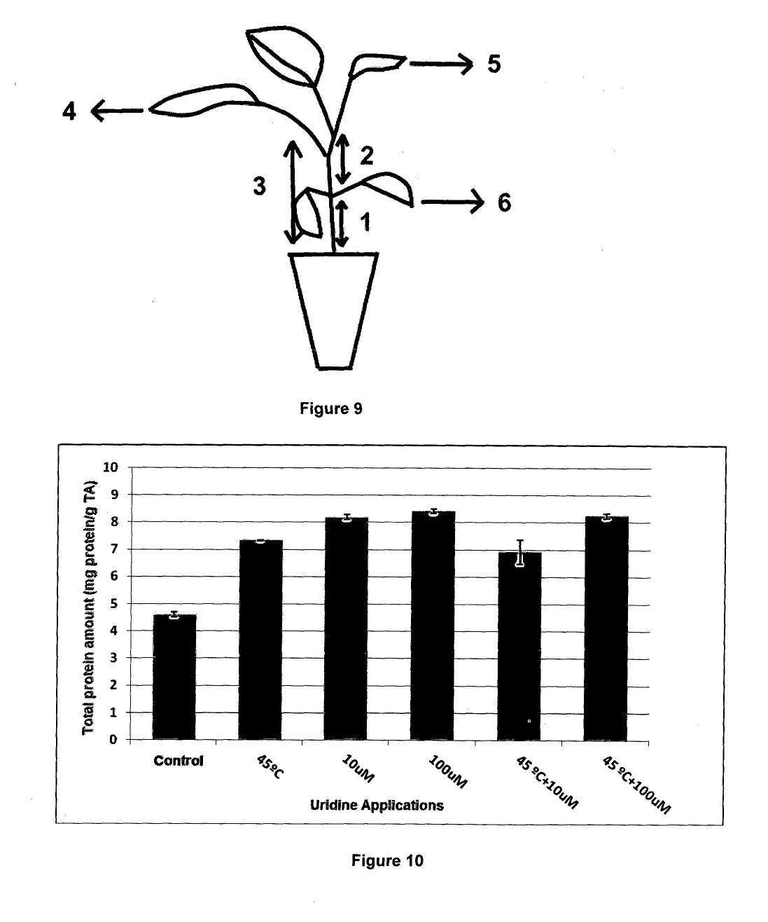

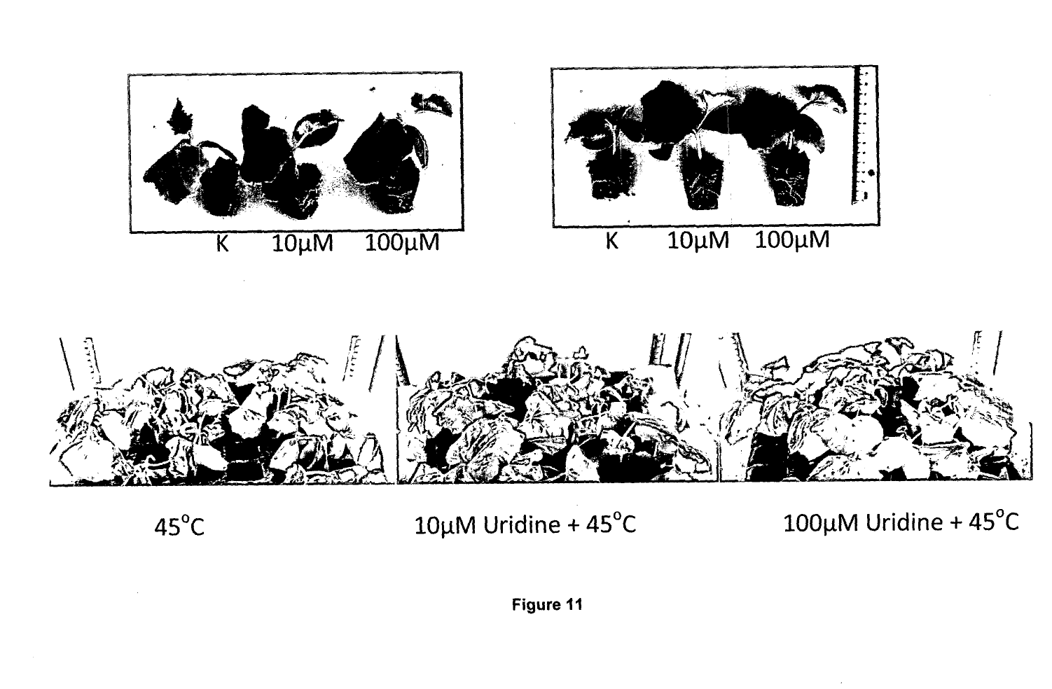

Plants are grown under light for 16 hours at 24° C. and 22° C. and under dark conditions for 8 hours at 20° C. daily in growth cabinet for 3 weeks until they have 2 actual leaves. Afterwards, measurement of plant parts are made as shown in FIG. 9 with below given details:

### 1. Hypocotyl Height (mm)

### 2. Epycotyl Height (mm)

### 3. Plant Height (mm)

4. First Actual leaf area (mm2)
5. Second Actual leaf area (mm2)
6. Cotyledon leaves

### Experiment 2

### Increase of Temperature Stress Tolerance of Plants Having Uridine Chemical, Administration

In the present invention, said uridine chemical is used on plants.

### The Amount of Uridine Chemical Usage in the Invention:

| RAW | PREFERRED AMOUNT | USABLE AMOUNT |
|---|---|---|
| MATERIAL | (gr) | (gr) |
| Uridine | 10⁻⁵-10⁻⁴ molar (1-100 | 10⁻⁹-1 molar (1 nanomolar- |
| | micromolar): 2.44-24.4 mg | 1 molar): 0.000244-244000 |
| | | mg |
| Water | 1 litre | 1 litre |

Said uridine is administered on cucumber (Cucumis sativus) plants in the preferred embodiment of the invention.
Their sowing is preferably made into vials of 72 such that 1 seed would be present per vial.
Said seeds are germinated at 25° C. in plant growth cabin.
Following the stage of germination, 10 ml of uridine solution prepared at 10 or 100 μM concentration is administered to the plants twice a week.
Water is used as dissolver in order to dissolve uridine (it is preferably dissolved in pure water and at room temperature).

### Preparation of Uridine Solution:

### For the Usable Amount of the Invention:

In order to prepare 10⁻⁹ M (1 nano molar) solution; 0.000244 mg uridine is dissolved in 1 L of water.
In order to prepare 1 M (1 molar) solution; 244000 mg uridine is dissolved in 1 L of water.

### For the Preferred Amount of the Invention:

In order to prepare 10 μM solution; 2.44 mg uridine is dissolved in 1 L of water.
In order to prepare 100 μM solution; 24.4 mg uridine is dissolved in 1 L of water.
Uridine solution should be prepared fresh for each administration.
Plants are grown under light for 16 hours at 24° C. and 22° C. and under dark conditions for 8 hours at 20° C. daily in growth cabinet for 3 weeks until they have 2 actual leaves.
For high temperature stress applications, the temperature of the growth cabin is increased gradually to 35, 40, and 45° C. and kept for 24 hours at each temperature level.
Following application of 45° C., total amount of soluble protein is measured in the leaf samples taken from the plants.
Total soluble protein extraction is made by using the method of Arora et. al. (1992, 1997) with some modifications suggested by Gulen and Eris (2003).
   Solution components used in total soluble protein extraction are:
   50 mM Borax (Sodium tetraborate)
   50 mM ascorbic acid
   1 mM PMSF (Phenylmethylsulphonyl)
   %1 β-mecaptoethanol
5 ml of the extraction solution prepared as given above is taken and homogenized together with 1 g of leaf sample in mortar. Homogenized samples are taken into 15 ml centrifuge tubes and centrifuged for 1.5 hours at 26 000 g and 4° C. Following centrifuge, the above liquid phase is taken and passed through 0.22 μm diameter filters.
Total soluble protein amount is determined according to Bradford (1976) method as proposed by Arora and Wisniewski (1994). The amount of protein in the supernatant obtained from the protein extraction is determined according to spectrophotometric measurements. Measurements are made by using single use polycarbonate basins at 595 nm wavelength and 0, 10, 20, 30, 40, 50 μg/μl BSA (Bovine serum albumin) standards are used for calculating total soluble protein amount. BSA stock solution is prepared as 5 mg BSA/ml extraction solution.

In a preferred embodiment of the invention; uridine solutions can be used in the form of application to the soil together with liquid fertilizers at certain ratios (liquid fertilizer components).

In a preferred embodiment of the invention; uridine solutions can be used by being added to the plant nutrient components in soilless agriculture applications (plant nutrient components).

In another preferred embodiment of the invention; uridine solutions can be used by being buried into soil after tabletting with suitable filling materials (tablet composition).

In another preferred embodiment of the invention; uridine solutions can be used together with irrigation water in drip irrigation system (drip irrigation).

In another preferred embodiment of the invention; uridine solution can be used in the form of coating by being sprayed onto leaves of plants and to fruits (spraying).

The effects of uridine on plants depends on concentration of application (application dose and frequency) and also application time, the physiological stage of the plant, age of the plant, species or type of the plant, member of the plant and the ecological conditions at the time of application (temperature, light, moisture, wind, soil etc.). As disclosed in the purpose and the method of application of the invention, the applications can be made when the plants are at the seed phase, plantlet, sapling, seedling, trees at the period of yield etc. different physiological and morphological phases. Moreover, it can also be applied on perennial, annual, herbaceous, ligneous, deciduous, evergreen etc. all plant types.

As a pyrimidine nucleoside, cytidine can also cause similar impacts with uridine on stress tolerances of plants, since both some part of it is transformed to uridine in plants and also it uses common pathways (e.g. Kennedy pathway) with uridine during its metabolism. The impacts of cytidine on the plants depends on concentration of application (application dose and frequency) and also application time, the physiological stage of the plant, age of the plant, species or type of the plant, member of the plant and the ecological conditions at the time of application (temperature, light, moisture, wind, soil etc.). As disclosed in the purpose and the method of application of the invention, the applications can be made when the plants are at the seed phase, plantlet, sapling, seedling, trees at the period of yield etc. different physiological and morphological phases. Moreover, it can also be applied on perennial, annual, herbaceous, ligneous, deciduous, evergreen etc. all plant types.

### REFERENCES

Allard F., Houde M., Krol M., Ivanov A., Huner N. P. A., Sarhan F. 1998. Betaine improves freezing tolerance in wheat. Plant Cell Physiol. 39, 1194-1202.
Alscher, G. R., Donahue, L. J., Cramer, L. C. 1997. Reactive oxygen species and antioxidants: relationship in gren cells. Physiologia Plantarum., 100: 222-223.
Arakawa T., Timassheff. 1985. The stabilization of proteins by osmolytes. Biophys. J. 47: 411-414.
Ashihara H., Adachi K., Otawa M., Yasumoto E., Fukushima Y., Kato M., Sano H., Sasamoto H., Baba S. 1997. Compatible solutes and inorganic ions in the mangrove plant Avicennia marina and their effects on the activities of enzymes. Zeitschrift für Naturforschung 52: 433-440.
Bashir N, Kuhen K, Taub M (1992) Phospholipids regulate growth and function of MDCK cells in hormonally defined serum free medium. In Vitro Cell Dev Biol. 28A: 663-668.
Bohnert H, Jensen R G. Strategies for engineering water stress tolerance in plants. Trends Biotechnol. 199:14:89-97.
Boston, R. S., Viitanen, P. V., Vierling, E. 1996. Molecular chaperones and protein folding in plants. Plant Mol. Biol., 32: 191-222.
Brachet J (1954) Effects of Ribonuclease on the Metabolism of Living Root-Tip Cells. Nature 174: 876-877.
Brady C. J., Gibson T. S., Barlow E. W. R., Speirs J., Wyn R., Jones G. 1984. Salt tolerance in plants. I. Ions, compatible organic solutes and the stability of plant ribosomes. Plant Cell Environ. 7: 571-578.
Cansev M, Marzloff G, Sakamoto T, Ulus I H, Wurtman R J (2009) Giving uridine and/or docosahexaenoic acid orally to rat dams during gestation and nursing increases synaptic elements in brains of weanling pups. Dev Neurosci., 31: 181-192.
Cansev M, Minbay Z, Goren B, Yaylagul E O, Cetinkaya M, Koksal N, Alkan T (2013) Neuroprotective effects of uridine in a rat model of neonatal hypoxic-ischemic encephalopathy. Neurosci Lett., 542: 65-70.
Cansev M, Ulus I H, Wang L, Maher T J, Wurtman R J (2008) Restorative effects of uridine plus docosahexaenoic acid in a rat model of Parkinson's disease. Neurosci Res., 62: 206-209.
Cansev M, Watkins C J, van der Beek E M, Wurtman R J (2005) Oral uridine-5′-monophosphate (UMP) increases brain CDP-choline levels in gerbils. Brain Res 1058: 101-108.
Charron J. -B. F., Breton G., Danyluk J., Muzac I., Ibrahim R. K., Sarhan F. 2002. Molecular and Biochemical Characterization of a Cold-Regulated Phosphoethanolamine N-Methyltransferase from Wheat. Plant Physiol. 129(1): 363-373.
Eris, A. Bahçe Bitkileri Fizyolojisi. Uluda\check{g} Üniversitesi Ziraat Fakültesi Ders Notlari, 2003; No:11, 5th Edition, p. 152.
Foyer, C. H., Descourvieres. P., Kunert, K. 1994. Protection against oxygen radicals: important defence mechanisms studied in transgenic plants. Plant Cell Environ., 17: 507-523.
Genchev D D and Mandel P (1974) CTP synthetase activity in neonatal and adult rat brain, J Neurochem 22: 1027-1030.
Giaveno C., Ferrero, J. 2003. Introduction of tropical maize genotypes to increase silage production in the central area of Santa Fe. Argentina Crop Breeding and Applied Biotechnology, 3(2): 89-94.
Hartl, F. U. 1996. Molecular chaperones in cellular protein folding. Nature, 381: 571-580.
Holguin S, Huang Y, Liu J, Wurtman R (2008b) Chronic administration of DHA and UMP improves the impaired memory of environmentally impoverished rats. Behav Brain Res., 191: 11-16.
Holguin S, Martinez J, Chow C, Wurtman R (2008a) Dietary uridine enhances the improvement in learning and memory produced by administering DHA to gerbils. FASEB J., 22: 3938-3946.
Incharoensakdi A., Takabe T., Akazawa T., effect of betaine on enzyme activity and subunit interaction of ribulose-1,5-biphosphate carboxylase/oxygenase from Aphahothece halophytica. Plant Physiol. 81: 1044-1049.
Kennedy E P and Weiss S B (1956) The function of cytidine coenzymes in the biosynthesis of phospholipides. J Biol Chem 222: 193-214.
Kumar, M. S., Kumar, G., Srikanthbabu, V., Udayakumar, M. 2007. Assessment of variability in acquired thermotolerance: Potentialoption to study genotypic response and the relevance of stress genes. Journal of Plant Physiology, 164(2): 111-125.
Larkindale, J, Huang, B. 2005. Effects of abcisic acid, salcylic acid, ethylene and hydrogen peroxide in thermotolerance and recovery for creeping bentgrass. Plant Growth Reg., 47: 17-28.
Lecca D and Ceruti S (2008) Uracil nucleotides: from metabolic intermediates to neuroprotection and neuroinflammation. Biochem Pharmacol 75: 1869-1881.
Levitt, J. 1980. Responses of Plants to Environmental Stresses, Vol. I, Academic Pres, New York, pp: 347-370.
Makela P., Peltonen-Sainio P., Jokinen K., Pehu E., Setala H., Hinkkanen R., Somersalo S. 1996. Uptake and translocation of foliar-applied glycinebetaine in crop plants. Plant Sci. 121: 221-230.
Mansour M. M. F. 1998 Protection of plasma membrane of onion epidermal cells by glycinebetaine and proline against NaCl stress. Plant Physiology and Biochemistry 36 (10): 767-772.
Mansour, M. M. F. 2000. Nitrogen containing compounds and adaptation of plants to salinity stress. Biol. Plant. 43, 491-500.
Mansour, M. M. F. 2000. Nitrogen containing compounds and adaptation of plants to salinity stress. Biol. Plant. 43: 491-500.
McKersie B. D., Leshem, Y. Y. 1994. Stress and stress coping in cultivated plants. Kluwer Academic Publishers, 256 pp.
McNeil S D, Nuccio M L, Hanson A D. 1999. Betaines and related osmoprotectants: targets for metabolic engineering of stress resistance. Plant Physiol. 120:945-949.
Mohanty A., Kathuria H., Ferjani A., Sakamoto A., Mohanty P., Murata N., Tyagi A. K. 2002. Transgenics of an elite indica rice variety Pusa Basmati 1 harbouring the codA gene are highly tolerant to salt stress. Theor. Appl. Genet. 106: 51-57.
Murkowski A. 2001 Heat stress and spermidine: effect on chlorophyll fluorescene in tomato plants. Biologia Plant. 44(1): 53-57.
Oota Y (1964) RNA in Developing Plant Cells. Annu Rev Plant Physiol 15: 17-36.
Paleg L G, Stewart G R, Bradbeer J W 1984 Proline and glycine betaine influence protein solvation. Plant Physiol. 75: 974-978.
Park E. J., Jcknic Z., Chen T. H. H. 2006. Exogenous application of glycinebetaine increases chilling tolerance in tomato plants. Plant Cell Physiol. 47, 706-714.
Park, E. J. et al. 2003. Genetic engineering of cold-tolerant tomato via glycinebetaine biosynthesis. Cryobiol. Cryotech. 49, 77-85
Peel G J, Modolo L V, Pang Y, Dixon R A (2009) The LAP1 MYB transcription factor orchestrates anthocyanidin biosynthesis and glycosylation in Medicago. Plant J 59: 136-149.
Peet, M. M., Willits, D. H. 1998. The effect of night temperature on greenhouse grown tomato yields in warm climate. Agric. Forest Meteorol., 92: 191-202.
Pelling G (1959) Chromosomal synthesis of ribonucleic acid as shown by incorporation of uridine labelled with tritium. Nature 184(Suppl 9): 655-656.
Pooler A M, Guez D H, Benedictus R, Wurtman R J (2005) Uridine enhances neurite outgrowth in nerve growth factor-differentiated PC12 cells. Neuroscience 134: 207-214.
Ross C (1965) Comparison of incorporation and metabolism of RNA pyrimidine nucleotide precursors in leaf tissues. Plant Physiol 40: 65-73.
Ross C and Cole C V (1968) Metabolism of cytidine and uridine in bean leaves. Plant Physiol 43: 1227-1231.
Sairam, R. K., Tyagi, A. 2004. Physiology and molecular biology of salinity stress tolerance in plants. Current Sci., 86: 407-421.
Sakai A., Yoshida S. 1968. The role of sugars and related compounds in variations of freezing resistance, Cryobiol. 5, 160-174.
Sakamoto A. and Murata N. 2000. Genetic engineering of glycinebetaine synthesis in plants: current status and implication for enhancement of stress tolerance. J. Exp. Bot. 51: 81-88.
Sakamoto T, Cansev M, Wurtman R J (2007) Oral supplementation with docosahexaenoic acid and uridine-5′-monophosphate increases dendritic spine density in adult gerbil hippocampus. Brain Res., 1182: 50-59.
Secades J J (2011) Citicoline: pharmacological and clinical review, 2010 update. Rev Neurol. 52 Suppl 2: S1-S62.
Smirnoff, N. 2005. Antioxidant and Raective Oxygen Species in Plants. Blackwell Publishing Ltd., U.K. p. 302.
Somersalo S., Kyei-Boahen S., Pehu E. 1996. Exogenous glycine betaine application as a possibility to increase low temperature tolerance of crop plants. Nordisk Jordbruksforskning 78: 10.
Teather L A, Wurtman R J (2006) Chronic administration of UMP ameliorates the impairment of hippocampal-dependent memory in impoverished rats. J Nutr., 136: 2834-2837.
Traut T W (1994) Physiological concentrations of purines and pyrimidines. Mol Cell Biochem. 140: 1-22.
Venkatesan, A., Chellappan, K. P. 1998. Accumulation of proline and glycine betaine in Ipomoea pescaprae induced by NaCl. Biol. Plant. 41, 271-276.
Wahid, A. 2007. Physiological implications of metabolites biosynthesis in net assimilation and heat stress tolerance of sugarcane sprouts. J. Plant Res., 120: 219-228.
Wahid, A. 2007. Physiological implications of metabolites biosynthesis in net assimilation and heat stress tolerance of sugarcane sprouts. J. Plant Res., 120: 219-228.
Wahid, A., Ghazanfar, A. 2006. Possible involvement of some secondary metabolites in salt tolerance of sugarcane. J. Plant Physiol., 163: 723-730.
Wang, W., Vinocur, B., Shoseyov, O., Altman, A. 2004. Role of plant heat-shock proteins and molecular chaperones in abiotic stress response. Trends in Plant Sci., 9(5): 244-253.
Wang, W., Vinocur, B., Shoseyov, O., Altman, A. 2004. Role of plant heat-shock proteins and molecular chaperones in abiotic stress response. Trends in Plant Sci., 9(5): 244-253.
Weibing X., Rajashekar C. B. 2001. Glycine betaine involvement in freezing tolerance and water stress in Arabidopsis thaliana. Environ. Exp. Bot. 46, 21-28.
Wery, J., Turc, O., Lecoeur, J. 1993. Mechanisms of resistance to cold, heat and drought in cool season legumes, with special reference to chickpea and pea: Breeding for stress tolerance in cool season food legumes, Eds: Singh, K. B., Saxena, M. C., Chichester, U.K., John Wiley and Sons. 271-291.
Williamson, J D (2002) Biotechnology; past, present and future. J. Am. Soc. Hort. Sci. 127:462-466.
Wurtman R J, Cansev M, Sakamoto T, Ulus I H (2009) Use of phosphatide precursors to promote synaptogenesis. Annu Rev Nutr. 29: 59-87.
Wurtman R J, Regan M, Ulus I, Yu L (2000) Effect of oral CDP-choline on plasma choline and uridine levels in humans”. Biochem Pharmacol. 60: 989-992.
Wurtman R J, Ulus I H, Cansev M, Watkins C J, Wang L, Marzloff G (2006) Synaptic proteins and phospholipids are increased in gerbil brain by administering uridine plus docosahexaenoic acid orally. Brain Res. 1088: 83-92.
Xing W. and Rajashekar C. B. 2001. Glycine betaine involvement in freezing tolerance and water stress in Arabidopsis thaliana. Environ. Exp. Bot. 46: 21-28.
Xue H W, Chen X, Mei Y (2009) Function and regulation of phospholipid signalling in plants. Biochem J 421: 125-156.
Yancey P H (1994) Compatible and counteracting solutes. in Cellular and Molecular Physiology of Cell Volume Regulation. ed Strange K (CRC Press, Boca Raton, Fla.), pp 81-109.
Yang W. -J., Rich P. J., Axtell J. D., Wood, K. V., Bonham C. C., Ejeta G., Mickelbart M. V., Rhodes D. 2003. Genotypic variation for glycine betaine in sorghum. Crop Sci. 43, 162-169.
Zhao Y., Aspinall D., Paleg L. G. 1992. Protection of membrane integrity in Medicago sati6a L. by glycine betaine against the effects of freezing, J. Plant Physiol. 140: 541-543.
Zhao Y., Aspinall D., Paleg L. G. 1992. Protection of membrane integrity in Medicago sati6a L. by glycine betaine against the effects of freezing, J. Plant Physiol. 140: 541-543.

1. The use of pyrimidine-containing compounds in increasing stress tolerances of plants.

2. Compounds according to claim 1 containing pyrimidines for increasing stress tolerances of plants, and it is characterized in that; it comprises use of uridine among said pyrimidine compounds.

3. Compounds according to claim 1 containing pyrimidines for increasing stress tolerances of plants, and it is characterized in that; it comprises use of cytidine among said pyrimidine compounds.

4. The use of pyrimidine-containing compounds in promoting growth and development of plants.

5. Use according to claim 4 in promoting growth and development of plants, and it is characterized in that; it comprises use of uridine among said pyrimidine compounds.

6. Use according to claim 4 in promoting growth and development of plants, and it is characterized in that; it comprises use of cytidine among said pyrimidine compounds.

7. Compounds according to claim 1 containing pyrimidines for increasing stress tolerances of plants, and it is characterized in that it comprises use together with at least one or a few of the group consisting of cytidine, thymidine; uracil, cytozine, and thymine, which are the base forms of these nucleosides; uridine-5′-monophosphate, uridine-5′-diphosphate, uridine-5′-triphosphate, cytidine-5′-monophosphate, cytidine-5′-diphosphate, cytidine-5′-triphosphate, thymidine-5′-monophosphate, thymidine-5′-diphosphate, thymidine-5′-triphosphate, which are the one-, two-, or three-phosphate-added forms of these nucleosides; and cytidine-5′-diphosphate choline, cytidine-5′-diphosphate ethanolamine, uridine-adenosine tetraphosphate, wherein choline, ethanolamine, adenosine etc. structures are added to nucleotides.

8. Use according to claim 1, and it is characterized in that; said solution is prepared between 10⁻⁹-1 molar.

9. Use according to claim 1, and it is characterized in that, said solution comprises 0.000244-244000 mg uridine in 1 litre of water.

10. Use according to claim 1, and it is characterized in that, said uridine solution is preferably prepared between 10⁻⁵ to 10⁻⁴ molar.

11. Use according to claim 1, and it is characterized in that, said solution comprises 2.44-24.4 mg uridine in 1 litre of water.

12. Use according to claim 1, and it is characterized in that, said solution is applied on the soil together with liquid manner.

13. Use according to claim 1, and it is characterized in that, said solution is applied in soilless agriculture by means of being added to plant nutrients.

14. Use according to claim 1, and it is characterized in that, said solution is applied by being buried into soil after tabletting with filler materials.

15. Use according to claim 1, and it is characterized in that, said solution is applied together with irrigation water in drip irrigation system.

16. Use according to claim 1, and it is characterized in that, said solution is applied in the form of spraying.
